(19) United States
(12) Patent Application Publication
(10) Pub. No.: US 2016/0166468 A1
(43) Pub. Date: Jun. 16, 2016

(54) Novel Medicine Bottle Caps with Daily Prescription Dose Reminder

(71) Applicants: Jayaseharan John Samuel, Pickerington, OH (US); SUDHA RAJAGOPALNADAR, Pickerington, OH (US)

(72) Inventors: Jayaseharan John Samuel, Pickerington, OH (US); SUDHA RAJAGOPALNADAR, Pickerington, OH (US)

(21) Appl. No.: 14/569,783

(22) Filed: Dec. 14, 2014

(51) Int. Cl. A61J 1/14

(52) U.S. Cl. CPC A61J 1/1412

(57) ABSTRACT

This patent describes a simple design of portable sickable reminder discs for medicine bottle cap that helps the patients avoid taking over dose and reminding patient of missed dose. The cap consists of a portable, stickable reminder disc with manual rotatable knobs or ridges adjusting one or two arrows pointing to the labels of daily doses and days of the week. These reminder discs can be pasted on the top or side of the medicine bottle cap.

### FIELD OF THE INVENTION

The present invention describes a novel and simple idea of making portable, sticky reminder discs containing daily dose and days of the week reminder for various type and size of prescription medicine bottles. The sticky bottom surface of the reminder discs allows to paste it on a top of a medicine bottle cap or side of a medicine bottle.

### BACKGROUND AND SUMMARY OF THE INVENTION

Conventionally, the medicine bottle from the pharmacy is an ordinary container with no dosage-remembering indicator. Taking medicine as prescribed by the doctor is very important for patient's wellbeing and potentially saves life. More often most of the patients do not easily remember whether they have taken a particular dose of medicine or not, prescribed by the doctor. That confusion led to accidentally taking more than one medicine dose at a time or simply forgetting the prescribed medical dose that affects the patients well being. The currently available designs are complicated to use for most of the patients [References 1-7].

This patent describes a novel and simple design of portable reminder disc containing daily dose and days of the week, for medicine bottle caps that prevents the patient taking more than one dose at a time or forgetting timely/daily dose of medicine. The idea here is to universally incorporate the dose and days of the week reminder in all available pharmacy prescription bottles at an affordable cost such that it benefits to all the patients wellbeing.

### BREIF SUMMARY OF THE INVENTION

The novel idea for this patent is to design of portable, sticky reminder discs that can be pasted on top of a medicine bottle cap or on the side of a medicine bottle, which contains daily dose and day reminder system to correctly remind the patient the next prescribed medicine on time. The reminder disc for various type and size medicine bottle caps with arrows rotatable by a knob pointing to daily doses label 1 to 8, and/or days of the week label, M for Monday, Tu for Tuesday, W for Wednesday, Th for Thursday , F for Friday, Sat for Saturday and S for Sunday are not available in the market and are not proposed in the literature. The portable, sticky discs for the medicine bottle caps are of several sizes that fit most medicine bottle containers.

### BRIEF DESCRIPTION OF THE SEVERAL VIEWS OF THE DRAWINGS

A brief description of the drawings, which are not necessarily drawn in scale are described below:

FIG. 1 is top view of the reminder disc containing daily dose reminder and days of the week reminder, where two rotatable plastic discs, one with the daily dose labels and the other with the days of the week labels are stacked on top of each other and stabled by a circular metallic binder. The two discs are independently rotated by the ridges on the discs to display the next dose or the next day of the week;

FIG. 2 is top view of the reminder disc containing daily dose only. The knob on the top of the disc rotated around the disc to point the daily dose taken;

FIG. 3a is top view of another design of the daily dose reminder disc where the ridge on the arrow is used to rotate the pointer to appropriate dose taken;

FIG. 3b is bottom view of the discs in FIGS. 1-3a which has a glue surface coating to stick on top or side of a medicine bottle cap.

FIG. 4 is the circular metallic binder.

### DETAILED DESCRIPTION OF THE INVENTION

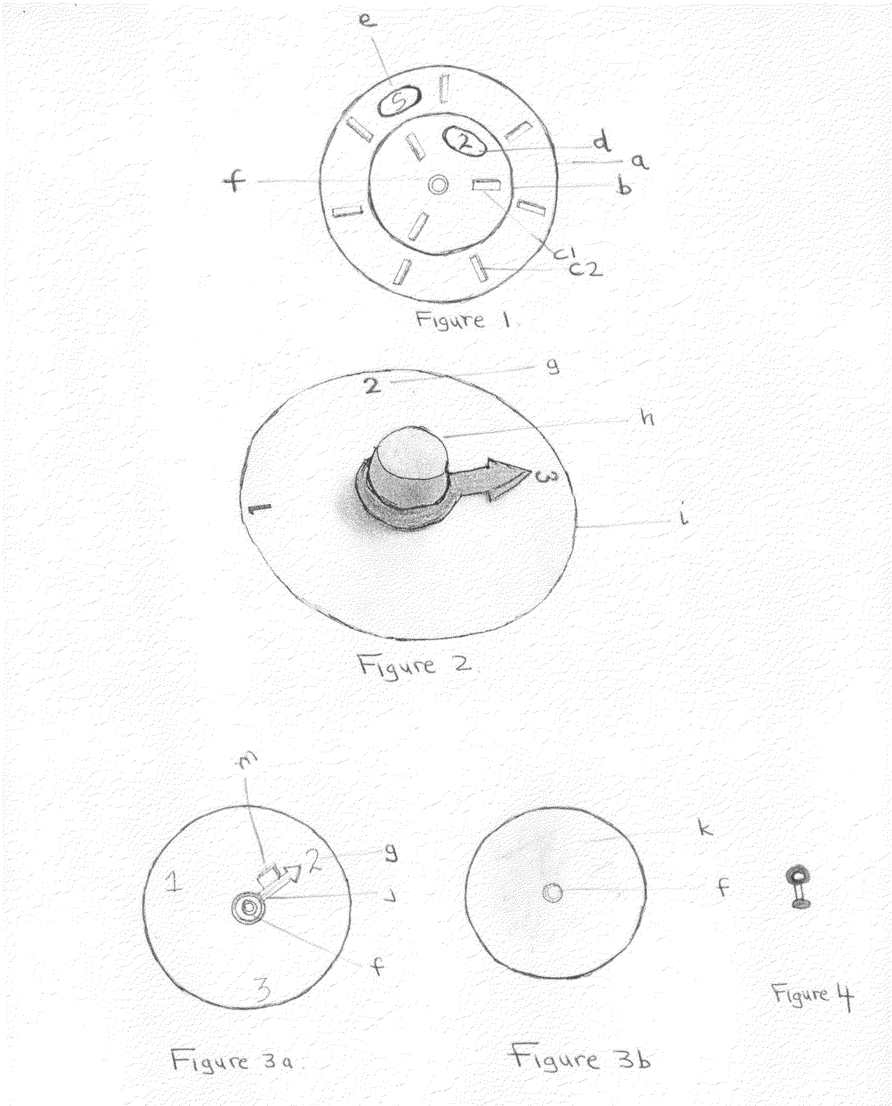

A more detailed description of the present invention and description of figures as follows: The portable discs in the FIGS. 1-3b are not to the scale and their sizes vary to fit various size and type medicine bottle caps.

The FIG. 1 shows the top view of the remainder disc containing both daily dose and days of the week reminder. It consists of independently rotatable two plastic circular disc bound together on a third disc by a metallic binder f. The top smaller circular disc b displays daily dose number 2 through a small opening d as shown in FIG. 1. Upon rotating the top disc with the ridges cl on the top of the disc it displace the daily dose , 1 to 8, printed beneath the disc. The second larger circular disc a which displays the days of the week S for Sunday through the opening e is independently moved with the ridges c2 on the disc. Upon rotating the disc ridges c2, the disc displays days of the week, S, for Sunday, M for Monday, Tu for Tuesday, W for Wednesday, Th for Thursday , F for Friday and Sat for Saturday. The discs are independently manually rotatable using the ridges such that ant any particular day, S (Sunday) the top disc can be rotated to display daily dose label from 1 to 8. The bottom view of the disc is shown in FIG. 3b. The bottom of the disc is coated with a glue k such that it can stick on the top of a medicine bottle cap.

FIG. 2 shows the top view remainder disc with only the daily dose designed for a three dose medicine bottle. The knob h can be rotated around the disc so that it can point to a particular dose taken for the day g. The bottom view has a glue surface k so that it can stick on to a medicine bottle cap.

FIG. 3a shows the remainder disc displaying only with daily dose g reminder. This reminder disc is also designed for a three dose medicine bottle. The disc and the arrow pointer are bound by a metallic binder f. The arrow pointer rotate around the disc with the help of the ridge m on the arrow to point the three labels on the disc.

FIG. 4 shows the diagram of the metallic binder. It has flat top and bottom connected by a narrow cylindrical tube. There are various other mechanism are used to rotate the reminder discs and arrow and also the FIGS. 1-4 are not drawn to the scale and only drawn to show their function for legal purpose.

I claim:

1. Multiple dose and day reminder portable and stickable reminder disc which consists of one or two rotatable arrows, pointing to the daily doses or days of the week printed labels, the labels 1 to 8 for daily doses and the labels ‘M, Tu, W, Th, F, Sat, S’ for days of the week, Monday, Tuesday, Wednesday, Thursday, Friday, Saturday and Sunday, respectively.

2. A reminder disc contains two rotating discs with ridges bound/stabled together by a metallic binder and are manually rotatable to show daily dose and days of the week labels.

3. A reminder disc contains a rotating knob or arrow with a ridge, to manually rotate around the disc of daily dose labels.

4. The disc of claims 1-3 further contains a glue coating bottom and made in different sizes and can be pasted on the top of cap or side of various size medicine bottle caps.
